(19) United States
(12) Patent Application Publication
(10) Pub. No.: US 2007/0160898 A1
(43) Pub. Date: Jul. 12, 2007

(54) Air battery and method for producing air electrode for air battery

(75) Inventors: Koshi Takamura, Osaka (JP); Harunari Shimamura, Osaka (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/651,601

(22) Filed: Jan. 10, 2007

(30) Foreign Application Priority Data
Jan. 12, 2006 (JP) 2006-004517

(51) Int. Cl. H01M 4/86; H01M 12/06; H01M 4/96; H01M 4/88

(52) U.S. Cl. 429/42; 429/27; 429/44; 502/101

(57) ABSTRACT

An air battery that is excellent in heavy-load discharge characteristics and storage characteristics is provided by ensuring the stability of the three-phase interface of a catalyst layer of an air electrode. The air battery has an air electrode including a catalyst layer that is bonded under pressure to a current collector and a water-repellent film. The catalyst layer includes a catalyst for reducing oxygen, a promoter for decomposing a product of the oxygen reduction, conductive carbon, and a binder. A non-polymeric fluorine compound is added to the catalyst layer in order to enhance the water repellency of the catalyst layer.

### FIELD OF THE INVENTION

The present invention relates to air batteries including an air electrode that utilizes oxygen as an active material, and, more particularly, to improvements in air electrodes.

### BACKGROUND OF THE INVENTION

Air electrodes used in air batteries are composed of a catalyst layer, a current collector, and a water-repellent film. In the catalyst layer, an oxygen-reducing reaction proceeds. The catalyst layer is typically composed of a catalyst for reducing oxygen (“oxygen-reducing catalyst”), a promoter for decomposing a product of the oxygen reduction, a conductive material, and a binder. The oxygen-reducing catalyst is often a carbon material, and, for example, activated carbon, graphite, or carbon black is used. The promoter is usually a manganese oxide. The oxygen-reducing catalyst and the promoter are mixed with conductive carbon and the mixture is bound by a fluorocarbon resin binder, such as polytetrafluoroethylene (PTFE). The fluorocarbon resin binder also serves as a water-repellent material. The current collector holds the catalyst layer while allowing electron transfer. The water-repellent film is a porous film made of a water-repellent polymer, such as PTFE, and prevents electrolyte from leaking out of the air electrode through the catalyst layer. Also, the water-repellent film has pores through which air is supplied to the catalyst layer.

It is believed that the oxygen-reducing reaction in the catalyst layer proceeds at the interface where the surfaces of the three faces, i.e., the catalyst (solid phase), electrolyte (liquid phase), and air (gas phase), come into contact with one another (“three-phase interface”). Hence, when the area of the three-phase interface is increased or when the efficiency of air supply to the three-phase interface per unit time is enhanced, the output characteristics of the air electrode can be enhanced.

In order to improve the output characteristics of the air electrode, for example, Patent Document 1 (Japanese Laid-Open Patent Publication No. Hei 6-267594) proposes forming a conductive water-repellent layer on the water-repellent film side of the catalyst layer, and optimizing the mixing ratio of the fluorocarbon resin binder contained in the catalyst layer, in order to increase the area of the three-phase interface. Also, Patent Document 2 (Japanese Laid-Open Patent Publication No. 2000-164262) proposes setting the porosity of the catalyst layer to 30 to 60%, in order to enhance the efficiency of air supply to the three-phase interface per unit time. Further, Patent Document 3 (Japanese Laid-Open Patent Publication No. 2005-19145) proposes forming two catalyst layers with different porosities such that the porosity of the catalyst layer adjacent to the water-repellent film is lower than the porosity of the catalyst layer adjacent to the negative electrode, in order to enhance the efficiency of air supply to the three-phase interface per unit time.

However, according to the method as proposed in Patent Document 1, in which a conductive water-repellent layer is formed on the water-repellent film side of the catalyst layer and the mixing ratio of the fluorocarbon resin binder contained in the catalyst layer is optimized, the mixing ratio of the fluorocarbon resin binder needs to be reduced to increase the area of the three-phase interface. If the mixing ratio of the fluorocarbon resin binder is reduced, the wettability of the catalyst layer with electrolyte increases and the penetration speed of electrolyte into the catalyst layer increases. Thus, in cases of long-time storage at room temperature and storage at high temperatures, the electrolyte undesirably penetrates into the catalyst layer. Hence, after the battery is stored, its discharge voltage lowers and a problem of storage characteristics degradation arises.

Also, according to the method as proposed in Patent Document 2, in which the porosity of the catalyst layer is set to 30 to 60% to enhance air supply efficiency, the amount of oxygen supplied into the catalyst layer per unit time increases, but the amount of steam or carbon dioxide introduced into the catalyst layer also increases. Thus, such steam or carbon dioxide has a remarkable adverse effect on long-term discharge such as light-load discharge, and a problem of degradation of discharge capacity or discharge duration arises.

Further, according to the method as proposed in Patent Document 3, in which the porosity of the catalyst layer adjacent to the water-repellent film is decreased to reduce the adverse effect of steam or carbon dioxide, a problem occurs in that a significant output increase is not possible, since the efficiency of air supply to the three-phase interface per unit time is dependent on the porosity of the catalyst layer adjacent to the water-repellent film.

Moreover, Patent Document 1 and Patent Document 3 have a common problem. That is, when two catalyst layers with different porosities are formed, the manufacturing process of the air electrode becomes complicated and the production efficiency of the air battery lowers.

### BRIEF SUMMARY OF THE INVENTION

In view of the above, the present invention intends to provide an air battery that is excellent in heavy-load discharge characteristics and storage characteristics by ensuring the stability of the three-phase interface of a catalyst layer of an air electrode.

In order to solve the above-mentioned problems, an air battery of the present invention includes an air electrode including a catalyst layer, a current collector, and a water-repellent film, wherein the catalyst layer contains a non-polymeric fluorine compound.

The non-polymeric fluorine compound contained in the catalyst layer of the air electrode of the present invention increases the water repellency of the catalyst layer and decreases the wettability of the catalyst layer with electrolyte. Thus, the penetration speed of electrolyte into the catalyst layer lowers and the storage characteristics of the air battery can be improved. Further, since a highly-water-repellent, highly-porous catalyst layer can be formed, heavy-load discharge characteristics can be improved without impairing storage characteristics.

According to the present invention, it is possible to provide an air electrode including a highly-water-repellent, highly-porous catalyst layer and, therefore, to provide an air battery that is excellent in storage characteristics and heavy-load discharge characteristics.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a perspective view of the main part of an air electrode in an Example of the present invention; and

FIG. 2 is a longitudinal sectional view of a button-type zinc-air battery in an Example of the present invention.

### DETAILED DESCRIPTION OF THE INVENTION

As described above, the air battery of the present invention has an air electrode including a catalyst layer, a current collector, and a water-repellent film, and the catalyst layer contains a non-polymeric fluorine compound. The non-polymeric fluorine compound contained in the catalyst layer decreases the wettability of the catalyst layer with electrolyte, thereby lowering the penetration speed of electrolyte into the catalyst layer. Thus, by controlling the mixing ratio of the non-polymeric fluorine compound contained in the catalyst layer and lowering the penetration speed of electrolyte into the catalyst layer, a reduction in the area of the three-phase interface in the catalyst layer during storage can be suppressed. It is therefore possible to suppress a discharge voltage drop after storage for a long period of time or at high temperatures.

The catalyst layer of the present invention contains a non-polymeric fluorine compound in addition to the typical components of the catalyst layer such as a catalyst for reducing oxygen (oxygen-reducing catalyst), a promoter for decomposing a product of the oxygen reduction, a conductive agent, and a binder. The preferable composition of this catalyst layer is 15 to 50 wt % of the oxygen-reducing catalyst, 15 to 35 wt % of the promoter, 5 to 15 wt % of the conductive agent, 1 to 45 wt % of the binder, and 0.5 to 50 wt % of the non-polymeric fluorine compound.

The non-polymeric fluorine compound may be any highly water-repellent powder of any composition, and it may have any shape such as scaly, spherical, or needle shape.

The non-polymeric fluorine compound is preferably fluorinated graphite or fluorinated pitch. The water-repellency of such a non-polymeric fluorine compound is resistant to deterioration even if particles of the non-polymeric fluorine compound become deformed due to shearing force when mixed and kneaded with other components of the catalyst layer.

Fluorinated graphite can be obtained by directly fluorinating graphite. Its composition formula is represented by (CF)ₙ or (C₂F)ₙ, and the optimum composition is CFₓ(0.5≦x≦1.0). As the fluorine content becomes lower, i.e., the carbon content becomes higher, the conductivity becomes higher. Also, fluorinated pitch can be obtained by directly fluorinating pitch. Its composition formula is represented by CFₓ(x<1.6). As the reaction temperature of pitch fluorination becomes lower, the fluorine content of the resulting fluorinated pitch tends to become lower. Similarly with fluorinated graphite, as the fluorine content of fluorinated pitch becomes lower, i.e., the carbon content becomes higher, the conductivity becomes higher. These compounds have very high water-repellency. When they are in the form of powder or a thin film, they have a contact angle with water of 145° or more, exhibiting super water-repellency. Thus, by adding a small amount of a non-polymeric fluorine compound to the catalyst layer and dispersing it evenly, the water-repellency of the catalyst layer is increased and the penetration speed of electrolyte into the catalyst layer is decreased.

Particles of a non-polymeric fluorine compound can be crushed by using a ball mill or the like. When a small particle size is desired, a crushing process with a ball mill or the like may be applied. The mean particle size of the non-polymeric fluorine compound is preferably in the range of 0.5 μm or more and 30 μm or less. If the mean particle size is less than 0.5 μm, particles of such a non-polymeric fluorine compound are apt to agglomerate and it becomes difficult to evenly disperse the non-polymeric fluorine compound in the catalyst layer. If it exceeds 30 μm, the particle size becomes greater than that of the catalyst components, so that the reaction of the catalyst components is impeded, which may result in degradation of discharge characteristics.

Also, the weight ratio (b/a) of the content (b) of the non-polymeric fluorine compound to the content (a) of the binder in the catalyst layer is preferably in the range from 0.1 to 11.5. If the ratio is less than 0.1, most of the surface of the non-polymeric fluorine compound is covered with the binder, so that the water-repellency of the catalyst layer decreases. As a result, the effect of lowering the wettability of the catalyst layer with electrolyte decreases. On the other hand, if the ratio is greater than 11.5, the water-repellency of the catalyst layer becomes too high, so that the penetration of electrolyte into the catalyst layer is impeded. As a result, the formation of the three-phase interface becomes insufficient, so that discharge characteristics degrade. The optimum b/a range for maintaining suitable water-repellency of the catalyst layer is from 0.25 to 3.0.

The total content of the binder and the non-polymeric fluorine compound is preferably in the range of 5 to 50% of the total weight of the catalyst layer. If it is less than 5%, the water repellency of the catalyst layer decreases and the wettability of the catalyst layer with electrolyte increases, so that storage characteristics degrade. If it is greater than 50%, the contents of the oxygen-reducing catalyst and the promoter in the catalyst layer decrease and the oxygen-reducing ability deteriorates, so that output characteristics degrade. In terms of maintaining suitable water repellency of the catalyst layer without impairing output characteristics, the total content of the binder and the non-polymeric fluorine compound is more preferably 20 to 45% of the total weight of the catalyst layer.

The porosity of the catalyst layer is preferably 50 to 80%. If the porosity of the catalyst layer is increased, the efficiency of the air supply to the three-phase interface is enhanced, so that heavy-load discharge characteristics are improved. In this case, however, due to the increase in the porosity of the catalyst layer, the penetration speed of electrolyte into the catalyst layer increases, so that storage characteristics degrade. Thus, increasing the porosity of the catalyst layer produces conflicting effects.

However, when the catalyst layer contains a non-polymeric fluorine compound, the water repellency of the catalyst layer increases and the wettability of the catalyst layer with electrolyte decreases. Thus, even if the porosity of the catalyst layer is increased, it becomes possible to decrease the penetration speed of electrolyte into the catalyst layer and to suppress degradation of storage characteristics.

As described above, the addition of the non-polymeric fluorine compound to the catalyst layer has an advantage in that the conflicting characteristics such as the heavy-load discharge characteristics and storage characteristics of air batteries can be improved at the same time. If the porosity of the catalyst layer is less than 50%, the efficiency of the air supply to the three-phase interface of the catalyst layer lowers and output characteristics degrade. If the porosity is greater than 80%, such significant increase in porosity negates the non-polymeric fluorine compound's effect of increasing the water repellency of the catalyst layer and thereby decreasing the electrolyte penetration speed, so that storage characteristics degrade. The porosity of the catalyst layer is more preferably in the range of 60 to 75%.

The catalyst layer preferably contains activated carbon and a manganese oxide. Activated carbon serves as a catalyst for reducing oxygen by two electrons, so that O₂H⁻and OH⁻ are produced as two-electron reduction products. The manganese oxide serves as a promoter for decomposing the produced O₂H⁻.

The oxygen-reducing catalyst is not limited to activated carbon and may be carbon material, platinum, or the like that serves as the oxygen-reducing catalyst. In terms of specific surface area and material costs, the optimum oxygen-reducing catalyst is activated carbon.

If the concentration of the oxygen two-electron reduction product O₂H⁻ in the catalyst layer rises, the potential of the air electrode lowers. Hence, the catalyst layer preferably contains a promoter for decomposing O₂H⁻. The promoter for decomposing O₂H⁻ is preferably a manganese oxide or a mixture of a manganese oxide and a metal powder such as nickel, but is not limited to these. Other examples include nickel-cobalt composite oxides, phthalocyanine compounds, silver, and platinum. The optimum promoter for decomposing O₂H⁻ is a manganese oxide in terms of its high catalytic activity and material costs.

As described above, the use of a highly-water-repellent, highly-porous air electrode makes it possible to provide an air battery that is excellent in storage characteristics and heavy-load discharge characteristics.

The present invention also provides a method for producing an air electrode for an air battery that includes a catalyst layer, a current collector, and a water-repellent film.

This production method includes the steps of:

(1) dry blending powders of catalyst-layer-components and a non-polymeric fluorine compound to form a dry mixture,

(2) adding a mixture of a binder, a surfactant, and water serving as a dispersion medium to the dry mixture and wet blending them to form a wet mixture,

(3) drying the wet mixture at 100° C. or less and crushing it into powder,

(4) compression molding the powder into a catalyst layer,

(5) bonding a current collector to one face of the catalyst layer under pressure,

(6) applying a water-repellent material onto the other face of the catalyst layer and heat treating the catalyst layer at 200° C. or more and 300° C. or less, and

(7) bonding a water-repellent film under pressure to the face of the catalyst layer to which the water-repellent material has been applied.

Preferably, the dispersion medium further comprises alcohol such as ethanol, methanol, or isopropyl alcohol.

According to this production method, first, all the materials excluding the binder are dry blended, so that the materials are evenly dispersed in a reliable manner. The non-polymeric fluorine compound has very high water-repellency and good slip. Thus, by sufficiently dispersing the non-polymeric fluorine compound by dry blending, the non-polymeric fluorine compound is prevented from becoming agglomerated in the catalyst components when being wet blended with the binder and the like. Further, by mixing alcohol with the binder and the like, the non-polymeric fluorine compound is more effectively prevented from becoming agglomerated in the catalyst components when being wet blended. The alcohol mixed therein decreases the surface tension of the dispersion medium containing the binder and the like, thereby enhancing the wettability of the dispersion medium with the catalyst components and the non-polymeric fluorine compound. As a result, the agglomeration of the non-polymeric fluorine compound can be prevented more effectively. After the catalyst layer is formed, it is heat treated at 200° C. or more and 300° C. or less, so that the surfactant in the catalyst layer is removed and the porosity of the catalyst layer is heightened.

As described above, according to the production method of the present invention, a highly-water-repellent, highly-porous catalyst layer can be formed in a simple manner. Therefore, without making the production process of the air electrode complicated, it is possible to heighten the production efficiency of the air battery.

Examples of the present invention are hereinafter described.

### EXAMPLE 1

(Method of Preparation of Air Electrode)

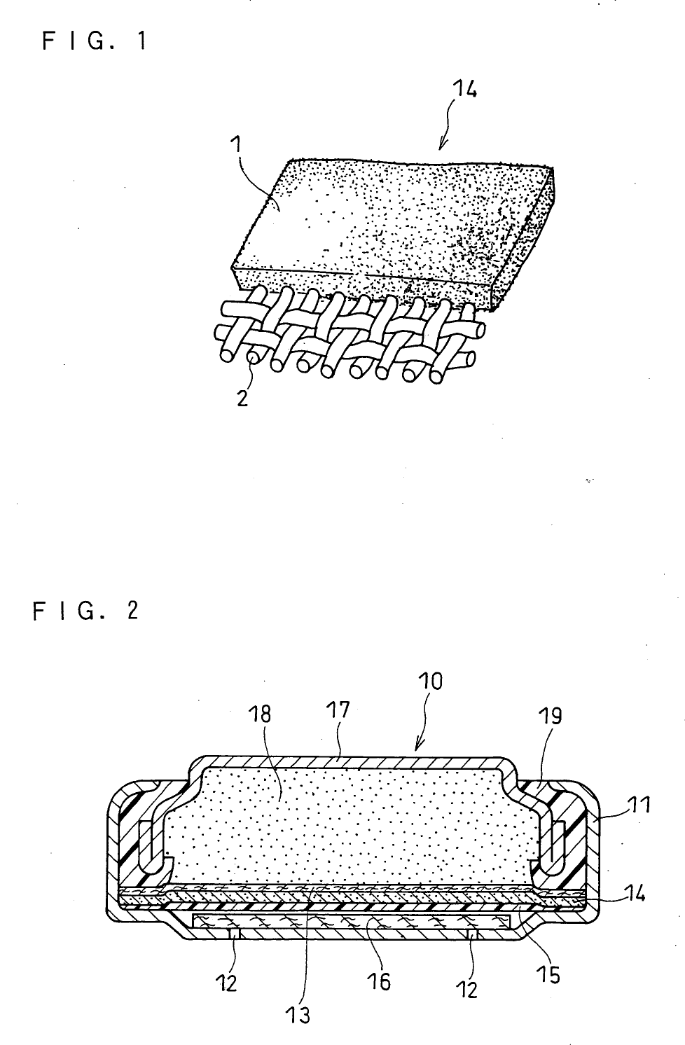

FIG. 1 is a perspective view of the main part of an air electrode in this example. A current collector 2 is bonded to one face of a catalyst layer 1. An assembly 14 of the catalyst layer 1 and the current collector 2 is combined with a water-repellent film to form an air electrode. The water-repellent film is bonded to the opposite face of the catalyst layer 1 from the current collector.

The catalyst layer 1 of the air electrode is composed of the following materials. Coconut husk activated carbon powder was used as the oxygen-reducing catalyst. The coconut husk activated carbon powder had a specific surface area of 1500 to 1900 m²/g and a median diameter of 2 to 7 μm. The median diameter as used herein was determined by laser diffraction/scattering particle size distribution analysis. The promoter for decomposing a product of oxygen reduction was a manganese oxide, namely Brownox (Mn₃O₄) available from Tosoh Corporation. Ketjen black ECP available from ketjen black Company Ltd. was used as the conductive carbon.

Fluorinated graphite or fluorinated pitch was used as the non-polymeric fluorine compound. The fluorinated graphite used was a grayish white powder prepared by directly fluorinating natural graphite under conditions of a reaction temperature of 600° C., a reaction time of 0.5 to 1 hour, and a fluorine pressure of 2.6×10⁴ Pa. The fluorinated graphite had a fluorine/carbon molar ratio (F/C) of approximately 1.0 and a median diameter of 8 to 12 μm as determined by laser diffraction/scattering particle size distribution analysis. The fluorinated pitch used was a white powder prepared by directly fluorinating coal pitch under conditions of a reaction temperature of 90° C., a reaction time of 6 to 12 hours, and a fluorine gas flow rate of 10 μm³/min. The fluorinated pitch had a fluorine/carbon molar ratio (F/C) of approximately 1.5 and a median diameter of 10 to 20 μm as determined by laser diffraction/scattering particle size distribution analysis.

The binder used was POLYFLON D1 available from Daikin Industries, Ltd., which is a PTFE dispersion in which PTFE is dispersed with a surfactant in water.

These materials were mixed and kneaded together in the following manner to form the catalyst layer 1. Predetermined amounts of the coconut husk activated carbon powder, the manganese oxide powder, the conductive carbon powder, and the non-polymeric fluorine compound powder were dry blended with a high speed mixer such that all the powders were evenly dispersed. The resulting powder mixture was mixed with the binder, water, and if necessary ethanol to form a wet mixture. The wet mixture was stirred and kneaded while a shearing force was applied thereto. Thereafter, the mixture was dried at 100° C. for several hours to evaporate the water, and the dried mixture was then crushed with a high speed mixer to obtain a catalyst powder mixture.

The catalyst powder mixture was molded into a sheet form in the following manner to obtain the catalyst layer. The catalyst powder mixture was fed at a constant speed between two reduction rolls so as to apply a constant pressure thereto, to form a sheet. The sheet was then bonded under pressure to a 30-mesh current collector net 2 made of nickel-plated stainless steel. This gave the catalyst layer-current collector assembly 14 composed of the sheet-like catalyst layer 1 and the current collector 2 bonded to one face of the catalyst layer 1. A 5-fold dilute aqueous solution of POLYFLON D1 was thinly applied onto the other face of the catalyst layer 1, i.e., the opposite face of the catalyst layer 1 from the face to which the current collector 2 was bonded. It was then dried at 250° C. for 5 hours. Due to the high-temperature drying, the surfactant contained in the binder was decomposed and removed, and only PTFE, which was the binder component, remained.

By performing the above-described steps, a catalyst layer with a predetermined porosity and a predetermined thickness was obtained. A water-repellent film 15, which was a PTFE micro-porous film, was bonded to the face of the catalyst layer to which the aqueous solution had been applied, by pressing with urethane rolls so as not to cause a porosity change. The resulting assembly was cut into predetermined dimensions, to obtain an air electrode.

(Method of Preparation of Air-Zinc Battery)

FIG. 2 is a longitudinal sectional view of a button-type zinc-air battery 10 in this example. The battery was of R44 size according to Japanese Industrial Standards (JIS), i.e., shaped like a button with a diameter of 11.6 mm and a height of 5.4 mm. This battery was produced as follows.

A positive electrode case 11 is composed mainly of an iron material SPCD (JIS standards), and is formed from a 0.2-mm-thick, nickel-plated plate by press working. The case 11 has a bottom whose central portion is depressed, and the depressed part of the bottom has four 0.5-mm-diameter through-holes as air vents 12. The case 11 is open at the top. The positive electrode case 11 has a side wall whose inner face is coated with polyamide resin in order to prevent electrolyte leakage.

On the inner face of bottom of the positive electrode case 11 are an air diffusion paper 16, the catalyst layer-current collector assembly 14 to which the water-repellent film 15 is bonded, and a separator 13. The air diffusion paper 16 is made of a 0.13-mm-thick vinylon non-woven fabric and allows air taken from the air vents 12 to be evenly diffused in the battery. The water-repellent film 15 is made of a 0.1-mm-thick PTFE micro-porous film with a porosity of 20% and allows oxygen to be supplied to the air electrode while preventing electrolyte from leaking out of the battery. The catalyst layer-current collector assembly 14 is punched out such that the current collector 2 has a sharp edge. Thus, the edge of the current collector 2 digs into the polyamide resin coated on the inner face of side wall of the positive electrode case 11, thereby ensuring reliable electrical connection between the current collector 2 and the positive electrode case 11. The separator 13 is a 0.1-mm-thick film composed of a polypropylene micro-porous film and a polypropylene non-woven fabric that are bonded together under pressure. The polypropylene micro-porous film used was subjected to a hydrophilicity treatment in advance. Seal tape (not shown) is affixed to the outer face of bottom of the positive electrode case 11 so as to close the air vents 12 when the battery is not in use. When the seal tape is removed from the positive electrode case 11, oxygen enters the battery, so that power-generating reaction starts.

A zinc alloy used in a gelled negative electrode 18 was prepared by atomization. Although a zinc alloy can be amalgamated by using mercury, the zinc alloy used in this example was free from mercury and contained 60 ppm of aluminum, 150 ppm of bismuth, 500 ppm of indium, and trace amounts of unavoidable impurities. The resulting powder was classified and its particle size was adjusted to 45 to 150 mesh. The gelled negative electrode 18 was prepared by adding the zinc alloy particles and sodium polyacrylate (gelling agent) to an electrolyte, which was an aqueous solution containing 40% by weight of potassium hydroxide and 3.5% by weight of zinc oxide. The mixing ratios of these components are: 100 parts by weight of the alkaline electrolyte, 50 parts by weight of the zinc alloy, and 3 parts by weight of the sodium polyacrylate.

The gelled negative electrode 18 is filled into a negative electrode case 17 serving as a negative electrode current collector. When the negative electrode case 17 is combined with the positive electrode case 11 to form a battery container, it seals the opening of the positive electrode case 11 while its inner wall comes into contact with the gelled negative electrode 18 containing the zinc alloy particles. The negative electrode case 17 is formed by press working from a 0.2-mm-thick, three-layer cladding material consisting of nickel, stainless steel, and copper, such that the face of the negative electrode case 17 to come into contact with the electrolyte is made of copper. An insulating gasket 19 made of 66 nylon is fitted between the negative electrode case 17 and the positive electrode case 11. The face of the insulating gasket 19 to come into contact with the negative electrode case 17 is coated with polyamide resin. Lastly, the opening of the positive electrode case 11 is crimped onto the outer face of the negative electrode case 17 with a gasket interposed therebetween. In this way, a sealed button-type zinc-air battery is completed.

According to the above-described procedure, a button-type zinc-air battery was produced by using an electrode that was prepared under the following conditions. The mixing ratios of the catalyst-layer-components were set to 35% by weight of activated carbon, 35% by weight of the manganese oxide, 10% by weight of conductive carbon, 19.1% by weight of PTFE, and 0.9% by weight of fluorinated graphite. The weight ratio (b/a) of the fluorinated graphite content (b) to the PTFE content (a) in the catalyst layer was set to 0.05, and the porosity was set to 70%.

### EXAMPLES 2 TO 21

Batteries of Examples 2 to 21 were fabricated in the same manner as in Example 1, except that air electrodes were prepared by varying the mixing ratios of the catalyst-layer-components and the weight ratio (b/a) as listed in Table 1.

In Examples 1 to 7, the ratio of the total content of the binder and fluorinated graphite to the catalyst layer and the porosity of the catalyst layer were kept constant, and the weight ratio (b/a) of the fluorinated graphite content (b) to the binder content (a) in the catalyst layer was varied.

In Examples 8 to 14, the weight ratio (b/a) and the porosity of the catalyst layer were kept constant, and the ratio of the total content of the binder and fluorinated graphite to the catalyst layer was varied.

In Examples 15 to 21, the weight ratio (b/a) and the ratio of the total content of the binder and fluorinated graphite to the catalyst layer were kept constant, and the porosity of the catalyst layer was varied.

### COMPARATIVE EXAMPLES 1 TO 4

Button-type air batteries were produced in the same manner as in Examples of the present invention, except that fluorinated graphite was not added to the catalyst layer.

In Comparative Examples 1 to 4, fluorinated graphite was not added to the catalyst layer, the porosity of the catalyst layer was kept constant, and the PTFE content in the catalyst layer was varied.

Table 1 shows the composition of the catalyst layer of the air electrode used in each of the above-mentioned batteries, the b/a ratio of the fluorinated graphite content (b) to the binder content (a) in the catalyst layer, the ratio of the total content of the binder and fluorinated graphite to the catalyst layer, and the porosity of the catalyst layer.

TABLE 1

| | Weight ratios of solid components (%) | | | | | | Ratio of total | |
|---|---|---|---|---|---|---|---|---|
| | Activated | Manganese | Conductive | PTFE | Fluorinated | | content of (a) | Porosity |
| | carbon | oxide | carbon | binder (a) | pitch (b) | (b)/(a) | and (b) (wt %) | (%) |
| Ex. 1 | 35 | 35 | 10 | 19.1 | 0.9 | 0.05 | 20.0 | 70 |
| Ex. 2 | 35 | 35 | 10 | 18.1 | 1.9 | 0.10 | 20.0 | 70 |
| Ex. 3 | 35 | 35 | 10 | 16 | 4 | 0.25 | 20.0 | 70 |
| Ex. 4 | 35 | 35 | 10 | 10 | 10 | 1.00 | 20.0 | 70 |
| Ex. 5 | 35 | 35 | 10 | 5 | 15 | 3.00 | 20.0 | 70 |
| Ex. 6 | 35 | 35 | 10 | 1.6 | 18.4 | 11.50 | 20.0 | 70 |
| Ex. 7 | 35 | 35 | 10 | 1.2 | 18.8 | 15.67 | 20.0 | 70 |
| Ex. 8 | 41.87 | 41.87 | 11.96 | 1.08 | 3.24 | 3.00 | 4.3 | 70 |
| Ex. 9 | 41.57 | 41.57 | 11.88 | 1.25 | 3.74 | 3.00 | 5.0 | 70 |
| Ex. 10 | 35 | 35 | 10 | 5 | 15 | 3.00 | 20.0 | 70 |
| Ex. 11 | 30.64 | 30.64 | 8.75 | 7.49 | 22.48 | 3.00 | 30.0 | 70 |
| Ex. 12 | 24.07 | 24.07 | 6.88 | 11.25 | 33.74 | 3.00 | 45.0 | 70 |
| Ex. 13 | 21.88 | 21.88 | 6.25 | 12.5 | 37.5 | 3.00 | 50.0 | 70 |
| Ex. 14 | 19.71 | 19.71 | 5.63 | 13.74 | 41.22 | 3.00 | 55.0 | 70 |
| Ex. 15 | 35 | 35 | 10 | 10 | 10 | 1.00 | 20.0 | 45 |
| Ex. 16 | 35 | 35 | 10 | 10 | 10 | 1.00 | 20.0 | 50 |
| Ex. 17 | 35 | 35 | 10 | 10 | 10 | 1.00 | 20.0 | 60 |
| Ex. 18 | 35 | 35 | 10 | 10 | 10 | 1.00 | 20.0 | 67 |
| Ex. 19 | 35 | 35 | 10 | 10 | 10 | 1.00 | 20.0 | 75 |
| Ex. 20 | 35 | 35 | 10 | 10 | 10 | 1.00 | 20.0 | 80 |
| Ex. 21 | 35 | 35 | 10 | 10 | 10 | 1.00 | 20.0 | 85 |
| Com. | 38.9 | 38.9 | 11.1 | 11.1 | 0 | 0 | 11.1 | 70 |
| Ex. 1 | | | | | | | | |
| Com. | 35 | 35 | 10 | 20 | 0 | 0 | 20.0 | 70 |
| Ex. 2 | | | | | | | | |
| Com. | 29.2 | 29.2 | 8.3 | 33.3 | 0 | 0 | 33.3 | 70 |
| Ex. 3 | | | | | | | | |
| Com. | 25 | 25 | 7.1 | 42.9 | 0 | 0 | 42.9 | 70 |
| Ex. 4 | | | | | | | | |

The batteries of Examples 1 to 21 and Comparative Examples 1 to 4 were evaluated for their discharge characteristics and storage characteristics. For the evaluation of discharge characteristics, the assembled batteries were continuously discharged at a constant current to measure the discharge duration. Specifically, the batteries were continuously discharged to a cut-off voltage of 0.9 V at constant currents of 2 mA and 15 mA in a 20° C. environment. For the evaluation of storage characteristics, the batteries with the air vents being sealed were stored in a 60° C. constant-temperature environment for 10 days and then continuously discharged to a cut-off voltage of 0.9 V at a constant current of 15 mA in a 20° C. environment to measure the discharge duration. Table 2 shows the average discharge duration of three batteries of each Example.

TABLE 2

| | | | Duration of |
|---|---|---|---|
| | Duration of | Duration of | continuous |
| | continuous | continuous | discharge at 15 mA |
| | discharge at 2 mA | discharge at 15 mA | after 10-day storage |
| | after assembly (h) | after assembly (h) | at 60° C. (h) |
| Ex. 1 | 304 | 37 | 28 |
| Ex. 2 | 305 | 37 | 32 |
| Ex. 3 | 304 | 37 | 35 |
| Ex. 4 | 304 | 37 | 35 |
| Ex. 5 | 305 | 37 | 36 |
| Ex. 6 | 304 | 37 | 33 |
| Ex. 7 | 304 | 37 | 29 |
| Ex. 8 | 304 | 39 | 30 |
| Ex. 9 | 304 | 39 | 36 |
| Ex. 10 | 305 | 37 | 36 |
| Ex. 11 | 305 | 38 | 38 |
| Ex. 12 | 305 | 37 | 37 |
| Ex. 13 | 304 | 37 | 34 |
| Ex. 14 | 304 | 31 | 30 |
| Ex. 15 | 305 | 34 | 31 |
| Ex. 16 | 305 | 39 | 37 |
| Ex. 17 | 305 | 42 | 40 |
| Ex. 18 | 304 | 43 | 41 |
| Ex. 19 | 304 | 43 | 41 |
| Ex. 20 | 304 | 43 | 37 |
| Ex. 21 | 304 | 43 | 32 |
| Com. | 305 | 36 | 4 |
| Ex. 1 | | | |
| Com. | 304 | 35 | 9 |
| Ex. 2 | | | |
| Com. | 300 | 23 | 18 |
| Ex. 3 | | | |
| Com. | 288 | 8 | 6 |
| Ex. 4 | | | |

Based on the results of Table 2, the effects of the present invention are hereinafter described.

In Comparative Examples 1 to 4, the non-polymeric fluorine compound was not added, and the mixing ratio of the PTFE binder was varied. In the order of Comparative Examples 1 to 4, the PTFE content in the catalyst layer increases and the contents of the catalyst components in the catalyst layer, i.e., activated carbon, the manganese oxide, and conductive carbon, decrease. The decrease in the contents of the catalyst components impairs discharge characteristics. Thus, the durations of continuous discharge at the constant currents of 2 mA and 15 mA after the assembly tended to decrease as the PTFE content increased. On the other hand, when the duration of continuous discharge at the constant current of 15 mA after assembly was compared with the duration of continuous discharge at the constant current of 15 mA after the 10-day storage at 60° C., the difference thereof tended to decrease as the PTFE content increased. This is probably because the increase in the PTFE content increased the water repellency of the catalyst layer, thereby suppressing the penetration of the electrolyte into the catalyst layer during the storage.

Thus, the batteries of Comparative Examples 1 to 4 that were continuously discharged at 15 mA after the 10-day storage at 60° C. were disassembled, and their air electrodes were taken out and the longitudinal sections of their catalyst layers were observed to check the degree of wettability of the catalyst layers. As a result, in all the air electrodes of Comparative Examples 1 to 4, penetration of the electrolyte into the catalyst layer was found. In Comparative Examples 1 and 2, it was found that the electrolyte penetrated into the border between the catalyst layer and the water-repellent film. In this way, it is believed that the permeation of the electrolyte through the pores of the catalyst layer caused a significant reduction in the three-phase interface in the catalyst layer, thereby resulting in a decrease in discharge duration.

The above results confirmed that in the air electrodes used in Comparative Examples 1 to 4, the penetration speed of the electrolyte into the catalyst layer during storage was high.

In Examples 1 to 7, the ratio of the total content of the binder and fluorinated graphite to the catalyst layer and the porosity of the catalyst layer were kept constant, and the weight ratio (b/a) of the fluorinated graphite content (b) to the binder content (a) in the catalyst layer was varied. Since fluorinated graphite was added to the catalyst layer, the durations of discharge at the constant current of 15 mA after the assembly were equivalent to those of Comparative Examples 1 and 2 and longer than those of Comparative Examples 3 and 4. With respect to the duration of discharge at 15 mA after the 10-day storage at 60° C., Examples 1 to 7 were significantly better than Comparative Examples 1 to 4. In Examples 1 to 7, the difference in 15 mA discharge duration between after the assembly and after the storage was small, and it is thus believed that the deterioration of these catalyst layers due to the storage is small. Examples 2 to 6, in which the b/a ratio was in the range of 0.1 to 11.5, in particular, exhibited longer 15 mA discharge durations after the storage than Examples 1 and 7.

The above results indicate that the weight ratio (b/a) of the fluorinated graphite content (b) to the binder content (a) in the catalyst layer is preferably in the range of 0.1 to 11.5. Further, Examples 3 to 5, in which the b/a ratio was in the range of 0.25 to 3.0, exhibited further increased 15 mA discharge durations after the storage. Therefore, the optimum weight ratio (b/a) of the fluorinated graphite content (b) to the binder content (a) in the catalyst layer is in the range of 0.25 to 3.0.

In Examples 8 to 14, the weight ratio (b/a) of the fluorinated graphite content (b) to the binder content (a) in the catalyst layer and the porosity of the catalyst layer were kept constant, and the ratio of the total content of the binder and fluorinated graphite to the catalyst layer was varied. The durations of 15 mA discharge after the assembly of Examples 8 to 13 were similar and somewhat longer than that of Example 14. Also, with respect to the difference in 15 mA discharge duration between after the assembly and after the storage, the difference in discharge duration of Example 8 was greater than those of Example 9 to 14. This suggests that the deterioration of the catalyst layer of Example 8 due to the storage is slightly greater.

The above results indicate that the ratio of the total content of the binder and fluorinated graphite to the catalyst layer is preferably in the range of 5 to 50% by weight. Further, in Examples 10 to 12, there was no difference in 15 mA discharge duration between after the assembly and after the storage, which suggests that almost no deterioration of the catalyst layers occurs during the 10-day storage at 60° C. Therefore, the optimum ratio of the total content of the binder and fluorinated graphite to the catalyst layer is in the range of 20 to 45% by weight.

In Examples 15 to 21, the weight ratio (b/a) of the fluorinated graphite content (b) to the binder content (a) in the catalyst layer and the ratio of the total content of the binder and fluorinated graphite to the catalyst layer were kept constant, and the porosity of the catalyst layer was varied. Examples 16 to 21, in which the porosity of the catalyst layer was in the range of 50 to 85%, exhibited longer 15 mA discharge durations after the storage than that of Example 15, which suggests that as the porosity of the catalyst layer becomes higher, the discharge characteristics after the assembly are improved. On the other hand, with respect to the 15 mA discharge duration after the storage, Example 21 exhibited a greater decrease than Examples 16 to 20, which suggests that when the porosity of the catalyst layer becomes excessively high, the deterioration of the catalyst layer due to the storage increases.

The above results indicate that the porosity of the catalyst layer is preferably in the range of 50 to 80%. Further, in the case of Examples 17 to 19, in which the porosity of the catalyst layer was in the range of 60 to 75%, the difference in 15 mA discharge duration between after the assembly and after the storage was small, which suggests that the deterioration of these catalyst layers is smaller. Hence, the optimum porosity of the catalyst layer is in the range of 60 to 75%.

It was confirmed that the addition of fluorinated pitch to the catalyst layer as the non-polymeric fluorine compound can also produce essentially the same effect as the use of fluorinated graphite.

The above results demonstrate that an air battery that is excellent in heavy-load discharge characteristics and storage characteristics can be obtained by adding a non-polymeric fluorine compound to the catalyst layer and controlling the mixing ratio of the non-polymeric fluorine compound and the porosity of the catalyst layer.

In the air battery according to the present invention, the water repellency of the catalyst layer is enhanced, so that the penetration speed of electrolyte into the catalyst layer is reduced and the stability of the three-phase interface is ensured. Therefore, the air battery according to the present invention is excellent in heavy-load discharge characteristics and storage characteristics and useful as the power source for various electronic devices including portable appliances.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. An air battery comprising an air electrode that comprises a catalyst layer, a current collector, and a water-repellent film, wherein said catalyst layer contains a non-polymeric fluorine compound.

2. The air battery in accordance with claim 1, wherein said non-polymeric fluorine compound is fluorinated graphite or fluorinated pitch.

3. The air battery in accordance with claim 1, wherein said catalyst layer comprises a catalyst for reducing oxygen, a promoter for decomposing a product of the oxygen reduction, conductive carbon, and a binder, and the weight ratio (b/a) of the content (b) of said non-polymeric fluorine compound to the content (a) of said binder is from 0.1 to 11.5.

4. The air battery in accordance with claim 1, wherein the total content of said binder and said non-polymeric fluorine compound is 5 to 50% of the total weight of said catalyst layer.

5. The air battery in accordance with claim 1, wherein said catalyst layer has a porosity of 50 to 80%.

6. The air battery in accordance with claim 3, wherein said catalyst for reducing oxygen is activated carbon, and said promoter is a manganese oxide.

7. A method for producing an air electrode for an air battery, said air electrode comprising a catalyst layer, a current collector, and a water-repellent film,
said method comprising the steps of:
dry blending a catalyst for reducing oxygen, a promoter for decomposing a product of the oxygen reduction, conductive carbon, and a non-polymeric fluorine compound to form a dry mixture,
adding a mixture of a binder, a surfactant, and water serving as a dispersion medium to said dry mixture and wet blending them to form a wet mixture,
drying said wet mixture at 100° C. or less and crushing it into powder,
forming said powder into a catalyst layer,
bonding a current collector to one face of said catalyst layer under pressure,
applying a water-repellent material onto the other face of said catalyst layer and applying a heat treatment thereto at 200° C. or more and 300° C. or less, and
bonding a water-repellent film to the other face of said catalyst layer under pressure.

8. The method for producing an air electrode for an air battery in accordance with claim 7, wherein said dispersion medium further comprises alcohol.
